(19) United States
(12) Patent Application Publication
(10) Pub. No.: US 2018/0198354 A1
(43) Pub. Date: Jul. 12, 2018

(54) METHOD FOR PRODUCING A STATOR OF A GENERATOR OF A WIND TURBINE, AND FORM-WOUND COIL, WINDING STRUCTURE AND STATOR

(71) Applicant: Wobben Properties GmbH, Aurich (DE)

(72) Inventors: Holger HÖLSCHER, Emden (DE); Gerald MÖHLMANN, Rhauderfehn (DE); Heino PICHOL, Aurich (DE); Jochen RÖER, Ganderkesee (DE)

(21) Appl. No.: 15/737,690

(22) PCT Filed: May 26, 2016
(86) PCT No.: PCT/EP2016/061916

§ 371 Date: Dec. 18, 2017

(30) Foreign Application Priority Data
Jun. 19, 2015 (DE) 102015211356.6

(51) Int. Cl. H02K 15/06; H02K 3/50; H02K 3/12; H02K 3/28; H02K 15/02; H02K 15/12

(52) U.S. Cl. CPC H02K 15/063; H02K 3/505; H02K 15/067; H02K 15/12; H02K 3/28; H02K 15/024; H02K 3/12

(57) ABSTRACT

A method for producing a stator having a form-wound coil for use in a generator of a gearless wind power installation is provided. Circumferentially adjacent form-wound coils are inserted into slots of a stator in succession, where a predetermined number of the first form-wound coils to be inserted are being-inserted only partially into the slots or are positioned in front of the slots and are only fully inserted into the corresponding slots together with a predetermined number of the form-wound coils to be inserted last. A winding structure and a stator having the form-wound coil are provided.

### BACKGROUND

### Technical Field

The invention relates to a method for producing a stator of a generator of a gearless wind power installation. The invention further relates to a form-wound coil and to a winding structure of a stator of a generator of a wind power installation, and also to a stator.

### Description of the Related Art

Stators of generators of gearless wind power installations are known which have a plurality of strands with in each case a plurality of windings. These windings are produced using an insulated wire, for example composed of copper. For this purpose, the wire of a strand is wound into the slots of the stator, such that a strand is produced from one continuous piece of the wire. This winding of the stator is very complicated and must expediently be performed by hand in order in particular at the bend points to monitor the integrity of the wires and also the insulation of the wire as early as during the winding process.

Furthermore, form-wound coils are known which correspond to prefabricated turns of a conductive material and which are inserted directly into the slots of a stator. The form-wound coils have connections which project far beyond the stator slot and by way of which the individual form-wound coils are connected to one another by soldering or welding such that the desired electrical interconnection of the winding structure as a whole is realized.

Owing to the high level of heat generation during the soldering process, the connections have to be situated at a great distance from the slot in order that the form-wound coil does not become too hot in the region of the slot and therefore lead to damage to the stator, in particular to an insulation with respect to the stator. Therefore, stators of this kind have a particularly great axial depth.

Furthermore, there is the risk of form-wound coils being damaged when they are inserted into the intended slots since the limbs of the individual form-wound coils intersect or overlap in the inserted state and therefore, when the last form-wound coils are inserted into the intended slots, the form-wound coils inserted first have to be entirely or at least partially withdrawn from the slots again in order to generate this overlap. In the process, the form-wound coils can become damaged, in particular plastically deformed, by the complete or in particular by the partial withdrawal from the slots such that reinsertion becomes difficult and there may be an undesired voltage in the form-wound coils after the subsequent reinsertion into the slots.

The German Patent and Trade Mark Office has, in the priority-founding German patent application, searched the following documents: Schmidt, W. et al.: “Umweltverträgliche Harzimprägnierung elektrischer Maschinen mittels Stromwärme” [“Environmentally compatible resin impregnation of electrical machines using current heat”], Tzscheutschler, R. et al.: “Technologie des Elektromaschinenbaus” [“Electrical engineering technology”], Heilles, Franz: “Wicklungen elektrischer Maschinen” [“Windings of electrical machines”] and Wiedemann, E. et al.: “Konstruktion elektrischer Maschinen” [“Construction of electrical machines”].

### BRIEF SUMMARY

Provided is a method of winding the stator with continuous strands, but which at the same time does not require an excessive depth of a stator, as is known in the prior art, or preferably minimizes the risk of damage to form-wound coils when they are inserted into the stator.

A method for producing a stator having form-wound coils of a generator of a gearless wind power installation is provided. For production purposes, the form-wound coils are inserted starting from any desired first slot by initially a predetermined number of form-wound coils to be inserted first being inserted only partially into the slots or being positioned in front of the slots and only being fully inserted into the corresponding slots together with a predetermined number of the form-wound coils to be inserted last.

In the case of a stator which is fitted with form-wound coils, the limbs of a plurality of other form-wound coils are inserted between the two limbs of each form-wound coil, as seen in the circumferential direction of the stator. Accordingly, the form-wound coils therefore intersect or overlap in the state in which they are inserted into the stator.

In order to make this arrangement, the form-wound coils which are inserted into the stator slots first have, up until now, been partially bent out of the slot again for the introduction of the form-wound coils to be inserted last. Owing to the production method, this bending-out operation is now no longer necessary, such that no damage to the insulation of the form-wound coils, or bending of the form-wound coils out of shape, occurs.

According to a further embodiment of the method, the stator is held and/or rotated in an upright position, that is to say with a substantially horizontal axis of rotation, by way of an auxiliary apparatus when the form-wound coils are inserted into the slots. As a result, a worker inserting the form-wound coils can remain in one position while the slots “pass by” the worker. As a result, production of the stator is simplified.

According to a further embodiment of the method, a template is used for the insertion. The template is positioned at least in front of the slots of the form-wound coils to be inserted first and in front of the slots of the form-wound coils to be inserted last. Then, all of the form-wound coils to be inserted, in the region of the template, are positioned in front of the slots on the template. The form-wound coils, in the region without the template, are placed directly into the slots. In the next step, the template is removed and the form-wound coils previously positioned on the template are jointly introduced into the slots provided for them. Therefore, the production of the stator is further simplified.

According to a further embodiment of the method, the template has holding means, such that the form-wound coils which are positioned on the template can be held in their position by way of the holding means. As a result, the form-wound coils to be inserted first are securely held in position when the stator is further rotated by way of the auxiliary apparatus. Therefore, the form-wound coils which are not yet introduced into the slots are prevented from falling down.

According to a further embodiment of the method, the form-wound coils each have two connections with in each case one thread. Two connections of different form-wound coils are then each connected by means of a flat copper bar or a copper strip which has two apertures, wherein two screws are screwed through the apertures into the thread of the connections of the form-wound coils, in particular with a predetermined torque, for this purpose. This screw connection provides for secure electrical connection of the form-wound coils.

According to a further embodiment of the method, the connections and the flat copper bar or the copper strip are ground and/or polished in the region of their contact areas, before the connection is established. According to a further embodiment, the connection is established at the latest two hours after the grinding and/or polishing.

Corrosion of the copper parts is therefore avoided because, after the connection, no further oxygen reaches the copper parts which are connected to one another. Therefore, an electrical connection with a particularly low electrical resistance is ensured.

In addition, provided is a template and/or an auxiliary apparatus for executing the method.

Provided is a form-wound coil of a stator of a generator of a gearless wind power installation, in particular for the method. The form-wound coil has an electrical conductor with a first and a second connection. The connections serve for electrical connection to a further form-wound coil. The connections further each have a thread in order to establish the electrical connections by means of screw connection.

It is therefore possible for a stator of a generator of a gearless wind power installation to be manufactured by the individual form-wound coils being inserted into the slots of the stator and the electrical connections of the individual form-wound coils being established by screw connections. Development of heat by soldering or welding on the completed generator when establishing the electrical connections can therefore be avoided.

It is therefore possible for the connections to be arranged substantially closer together on the stator body without the risk of damage to the stator, in particular to an insulation. Therefore, a stator can be realized which has a substantially smaller axial depth. Furthermore, the stator can be produced by simply inserting the form-wound coils, without the need for complicated winding of the windings.

The generator is preferably in the form of a ring generator. Accordingly, the magnetically active regions of the rotor and of the stator, specifically in particular the laminated cores of the stator and of the rotor, are arranged in a ring-shaped region around the air gap which separates the rotor and stator. Here, the generator is free from magnetically active regions in an inner region with a radius of at least 50% of the mean air gap radius.

A ring generator can also be defined as being one in which the radial thickness of the magnetically active parts or in other words of the magnetically active region, specifically the radial thickness from the inner edge of the pole wheel to the outer edge of the stator, or from the inner edge of the stator to the outer edge of the rotor, in the case of an external rotor, is smaller than the air gap radius, in particular one in which the radial thickness of the magnetically active region of the generator amounts to less than 30%, in particular less than 25%, of the air gap radius. In addition or as an alternative, a ring generator can be defined as being one in which the depth, specifically the axial extent of the generator, is smaller than the air gap radius, in particular one in which the depth amounts to less than 30%, in particular less than 25%, of the air gap radius. In addition or as an alternative, a ring generator is of multipole design, and specifically has at least 48, 96, in particular at least 192, rotor poles.

According to a further embodiment, the thread of the connections is an internal thread. An internal thread is advantageous because the electrical connections of the form-wound coils can be produced by means of conventional screws with an external thread. In addition, an internal thread is better protected against external influences than an external thread.

According to a further embodiment, at least one of the connections of the form-wound coil is angled in relation to a coil longitudinal axis or in relation to a line which is parallel to the coil longitudinal axis. Furthermore, the other connection is not angled in relation to a coil longitudinal axis or in relation to a line which is parallel to the coil longitudinal axis. That is to say, the two connections are at a different angle in relation to a coil longitudinal axis or in relation to a line which is parallel to the coil longitudinal axis, which angle, according to one preferred embodiment, lies in the range of from 45 to 90°, particularly preferably in the range of from 60 to 80°.

According to one embodiment, a form-wound coil has two substantially parallel elongate limbs, wherein each limb has a length of at least 80 cm, at least 100 cm or at least 120 cm. Furthermore, this embodiment of the form-wound coil comprises a first end, at which the limbs are connected to one another, and a second end, at which the connections of the form-wound coil are provided. Since two limbs of different form-wound coils are provided in each slot of the stator, the connections of the form-wound coils are, after being arranged in the stator, situated very close together. Owing to the angling of at least one of the connections with respect to the other connection, however, an electrical connection to the connections can be established in a simple manner because said connections are therefore easily accessible. An electrical connection of the form-wound coils can therefore be established in a simple manner, and furthermore, the risk of a short circuit of two touching connections is counteracted.

According to a further embodiment, the conductor has a plurality of layers, in particular two layers. This plurality of layers are in each case connected to a connection. According to a particularly preferred form, each layer is formed with a flat copper bar, a copper strip or a flat copper wire. A flat copper wire which has a rectangular cross section and a height of 0.8 to 1 cm and a width of 1 to 2 cm is preferred. The plurality of layers of the conductor are then arranged or stacked one above the other such that the layers point toward one another by way of one of their relatively wide sides.

According to a further embodiment, the form-wound coil has a plurality of turns of the conductor. According to a particularly preferred embodiment, the form-wound coil comprises four turns.

According to a further embodiment, the form-wound coil assumes at least three different forms, wherein the connections of the different forms are at different distances from a geometric center point of the form-wound coil. During the subsequent insertion of the form-wound coils into the stator slots, connection of the form-wound coils is therefore possible in a simple manner because adjacent first connections have different heights and adjacent second connections likewise have different heights and are therefore easily accessible for establishing the electrical connections.

A conductor with a single layer has to be twice as thick as a conductor with two layers in order to achieve the same electrical properties as the conductor with two layers. The use of a comparatively flat copper wire is therefore advantageous for producing the form-wound coil in a plurality of layers as a conductor with a plurality of windings because it is comparatively easier to bend. A form-wound coil with a plurality of turns can therefore be produced in a particularly simple manner.

According to a further embodiment, the conductor or each layer of the conductor of the form-wound coil is insulated. According to a particularly preferred embodiment, this insulation is an insulation by means of lacquer and/or powder coating. Insulation of the form-wound coil is therefore possible as early as before the production of the form-wound coil by simple application of the insulating layer, for example of an insulating lacquer, to the conductor in the unformed state, such that a reliable insulation can be produced in a simple manner.

This insulation serves—in addition to a slot insulation which is inserted into the slots later, to insulate the form-wound coil from the likewise conductive stator material. Therefore, complete enwinding of the form-wound coil for insulation purposes, also referred to as insulating winding, before the insertion of the form-wound coils into the stator slots can be dispensed with. An insulation winding of the form-wound coils is disadvantageous because the insulating winding impedes the heat dissipation from the form-wound coil during operation. Accordingly, a form-wound coil without enwinding for insulation purposes, according to the present exemplary embodiment, is advantageous with regard to its heat dissipation.

According to a further embodiment, the connections are connected to the conductor by means of soldering or welding. The connection of the conductor to the connections, which have the thread, is particularly advantageously established by induction welding.

A particularly low contact resistance of the connecting point is achieved by virtue of soldering or welding the connections to the conductor. Soldering or welding the connections to the conductor is also possible as long as the form-wound coil is not yet inserted into the stator, because the development of heat during the soldering or welding cannot damage the stator.

According to a further embodiment, the conductor, in the region of the connection to at least one connection, has an insulation composed of glass-fiber-reinforced plastic. Said plastic serves to insulate at least one part of the conductor and/or one part of the connection.

A form-wound coil whose conductor is insulated, for example, by means of lacquer and/or powder coating has to, for the purpose of soldering or welding the connection, be stripped of insulation in the region of the soldering or welding point. This is realized, for example, by virtue of the insulation being burned off in this region. Since there is the risk of a short circuit in adjacent connecting regions of adjacent conductors with their connections, owing to the insulation being stripped, after the arrangement of the form-wound coils in the slots of the stator, the glass-fiber-reinforced plastic prevents a short circuit of this kind.

According to a further embodiment, the form-wound coil, in the region of the connection, has a spacer which prevents adjacent connections from touching as a result of vibrations of the stator during operation of the stator, which could result in a short circuit. According to these exemplary embodiments, short circuits are accordingly counteracted.

According to a further embodiment, the conductor and the connections of the form-wound coil are manufactured using copper or a copper alloy. Copper or a copper alloy advantageously have a low resistance, such that as high a proportion of electrical energy as possible and as low a proportion of thermal energy as possible are generated by the generator.

Provided is a winding structure of a stator of a generator of a wind power installation. A winding structure corresponds to the entirety of the form-wound coils with their connections which are used in the stator of a generator of a wind power installation. The winding structure comprises a plurality of form-wound coils, in particular in line with one of the preceding embodiments. The form-wound coils each have an electrical conductor with a first connection and a second connection. The connections each comprise a thread. Furthermore, the winding structure comprises a plurality of connecting elements, in each case for electrically connecting two connections of two form-wound coils using screw connections.

Therefore, owing to the thread, a winding structure for a stator can be realized which has a substantially smaller depth than a winding structure for a stator with conventional form-wound coils. Furthermore, the stator can be produced by simply inserting the form-wound coils, without the need for complicated winding of the windings.

According to a further embodiment of the winding structure, the form-wound coils are connected to one another in such a way that the winding structure has six phases. That is to say, the form-wound coils are connected to one another in such a way that six strands are provided. In this case, a first and a second strand are associated with a first phase, a third and a fourth strand are associated with a second phase, and a fifth and a sixth strand are associated with a third phase. Furthermore, according to a further embodiment, the winding structure is subdivided into a plurality of sections or segments which are connected in parallel. That is to say, the six strands are subdivided into a plurality of, for example 2, 4, 6 or 8, segments, wherein identical phases or strands of each segment are connected in parallel. This results in a reduction in the maximum voltage induced in the strands by a quarter.

According to one embodiment of the winding structure, the connections of two form-wound coils are connected by way of connecting elements. The connecting elements comprise a conductive connector, in particular a flat copper bar or a copper strip, which has two apertures at its outer ends. According to a further embodiment, the ends are slightly angled. The apertures are produced, for example, by drilling. Furthermore, the connecting element comprises two screws which are produced, in particular, using brass.

Accordingly, the conductive connector with its apertures, that is to say for example drilled holes, is positioned in front of the threads of the two connections of two different form-wound coils, and the screws are passed through the apertures and screwed into the thread of the connection. An electrical connection with a low contact resistance can therefore be established.

According to a further embodiment of the winding structure, the connecting elements and the form-wound coils have a substantially identical coefficient of thermal expansion. This ensures that, despite the heat generated during operation of the winding structure, the screw connections remain secure.

Provided is a stator of a generator of a wind power installation. The stator comprises a plurality of circumferential slots, wherein respectively adjacent slots are at substantially the same distance from one another. Form-wound coils according to one of the preceding embodiments are inserted into the slots.

Therefore, owing to the thread, a stator can be realized which has a substantially smaller depth than a stator with conventional form-wound coils. Furthermore, the stator can be produced by simply inserting the form-wound coils, without the need for complicated winding of the windings.

According to one embodiment, the stator is formed with form-wound coils and a winding structure in line with one of the preceding embodiments.

### BRIEF DESCRIPTION OF THE SEVERAL VIEWS OF THE DRAWINGS

Further embodiments of the invention can be gathered from the exemplary embodiments discussed in more detail with reference to the drawings, in which:

FIG. 1 shows a wind power installation,

FIG. 2 shows a schematic side view of a generator,

FIG. 3 shows a first view of a form-wound coil,

FIG. 4 shows a further view of a form-wound coil,

FIG. 5 shows a detail of a perspective view of a stator,

FIG. 6 shows a stator with six inserted form-wound coils,

FIG. 7 shows a plan view of an exemplary embodiment of a generator,

FIG. 8 shows a view, from the center of the stator, of the form-wound coils which are inserted into a stator, and

FIG. 9 shows an auxiliary apparatus for the method.

### DETAILED DESCRIPTION

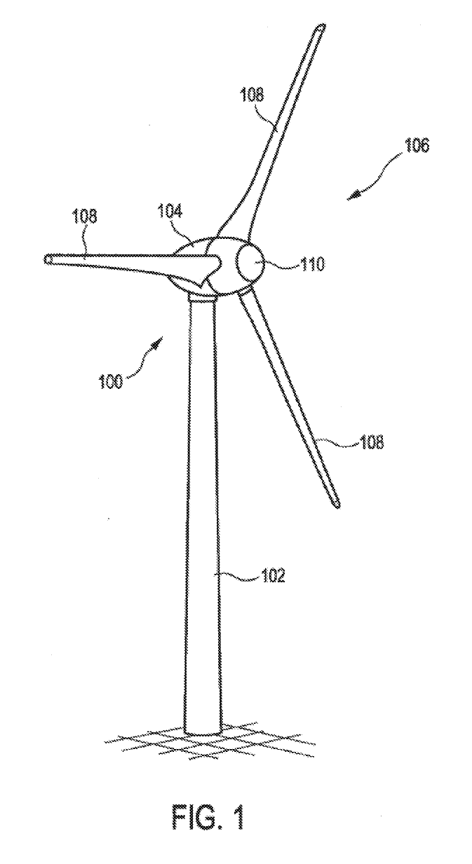

FIG. 1 is a schematic illustration of a wind power installation. The wind power installation 100 has a tower 102 and a nacelle 104 on the tower 102. An aerodynamic rotor 106 with three rotor blades 108 and a spinner 110 is provided on the nacelle 104. During operation of the wind power installation, the aerodynamic rotor 106 is set in a rotational movement by the wind and therefore also rotates a rotor of a generator, which is coupled directly or indirectly to the aerodynamic rotor 106. The electrical generator is arranged in the nacelle 104 and generates electrical energy. The pitch angles of the rotor blades 108 can be varied by means of pitch motors at the rotor blade roots of the respective rotor blades 108.

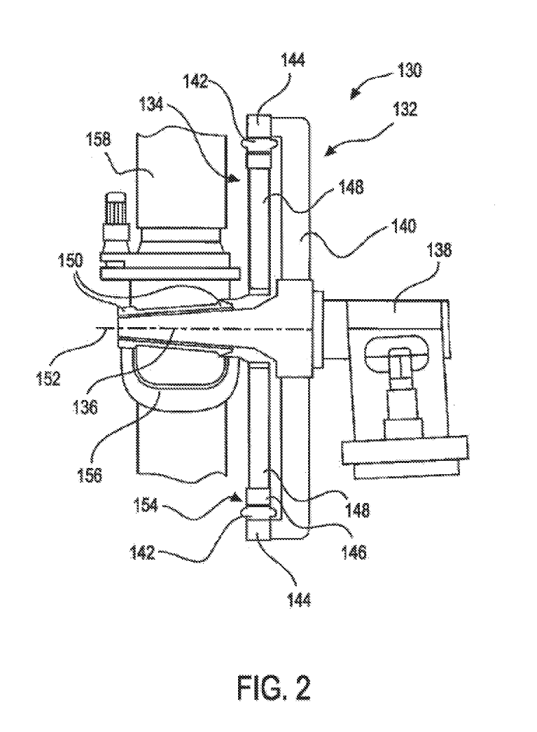

FIG. 2 shows a schematic side view of a generator 130. Said generator has a stator 132 and an electrodynamic rotor 134 which is mounted such that it can rotate relative to said stator, and is fastened by way of its stator 132 to a machine support 138 by means of a journal 136. The stator 132 has a stator support 140 and stator laminated cores 142, which form stator poles of the generator 130 and which are fastened by means of a stator ring 144 to the stator support 140.

The electrodynamic rotor 134 has rotor pole shoes 146 which form the rotor poles and which, by means of a rotor support 148 and bearing 150, are mounted on the journal 136 such that they can rotate about the axis of rotation 152. The stator laminated cores 142 and rotor pole shoes 146 are separated by only a narrow air gap 154, which is a few mm thick, in particular less than 6 mm, but has a diameter of several meters, in particular more than 4 m.

The stator laminated cores 142 and the rotor pole shoes 146 form in each case one ring and, together, are also ring-shaped, such that the generator 130 is a ring generator. The electrodynamic rotor 134 of the generator 130 intentionally rotates together with the rotor hub 156 of the aerodynamic rotor, of which roots of rotor blades 158 are indicated.

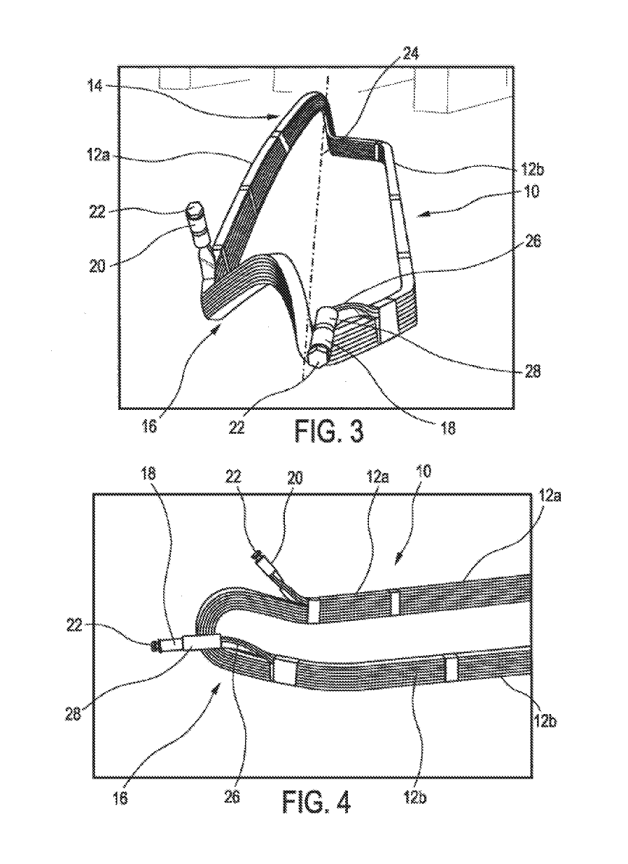

FIG. 3 shows a view of an exemplary embodiment of a form-wound coil 10. The form-wound coil 10 has two limbs 12a, 12b. The limbs 12a, 12b run parallel to one another and have a length of greater than 90 cm. The two limbs 12a, 12b are connected to one another at a first end 14 and at a second end 16.

The second end 16 of the form-wound coil 10 has a first connection 18 and a second connection 20. The connections 18, 20 have an internal thread. Screws 22 are screwed into the internal thread of the connections 18, 20. The second connection 20 is angled, and the first connection 18 is not angled, in relation to a coil longitudinal axis 24 or in relation to a line which is parallel to the coil longitudinal axis 24.

The form-wound coil 10 comprises a conductor 26 and the connections 18 and 20 which are manufactured using copper. Furthermore, the screws 22 are manufactured using brass. The conductor 26 is composed of two layers of a flat wire which are formed into four turns. That is to say, two layers of the flat wire, which is also referred to as flat copper wire, are connected to the two connections 18, 20.

The form-wound coil 10 is therefore formed with these two layers and four turns such that eight layers of the flat copper wire are arranged or stacked one above the other in the region of the limbs 12a, 12b and in the region of the first end 14.

Owing to the connections 18, 20 which are passed out, six layers remain arranged one above the other in the region of the second end 16. The flat copper wire is insulated by lacquering. In the connecting region of the conductor 26 to the connections 18, 20, however, the insulation has been removed in order to connect the connections 18, 20 to the conductor 26 by induction welding. In the region of the connection of the first connection 18 to the conductor 26, a glass-fiber-reinforced plastic 28 is applied in order to reinsulate said part from which the insulation of the conductor 26 has been removed.

According to one exemplary embodiment which is not illustrated, a glass-fiber-reinforced plastic of this kind is also provided in the connecting part between the second connection 20 and the conductor 26. In order that the form-wound coil 10 maintains its shape, the layers of the form-wound coil are enwound in narrow regions. However, an insulation winding is not provided.

FIG. 4 shows a further view of the form-wound coil 10, wherein, here, the second end 16 with a part of the limbs 12a, 12b is illustrated from the side. The exemplary embodiment of the form-wound coil illustrated in FIG. 4 corresponds to the exemplary embodiment of the form-wound coil in FIG. 3.

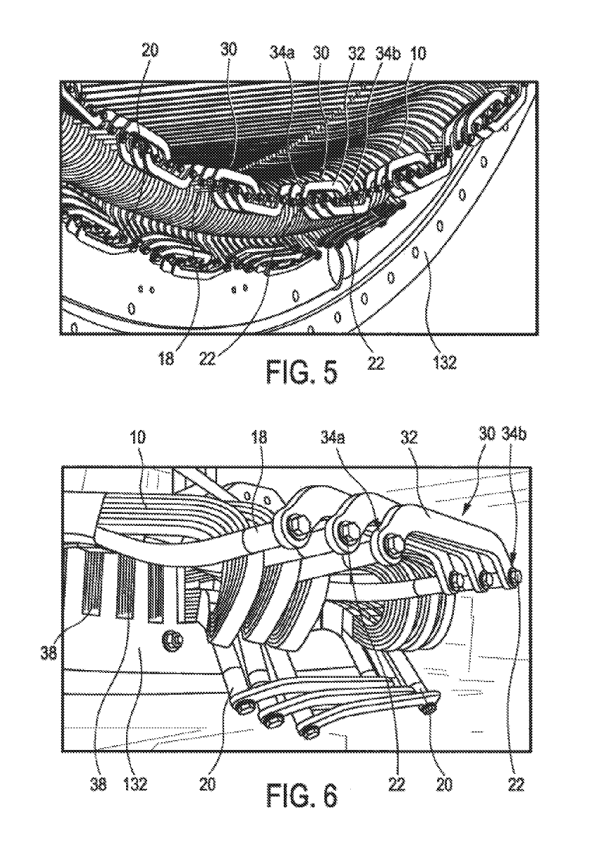

FIG. 5 shows a perspective view of a stator 132 of a generator 130 of a wind power installation 100 with form-wound coils 10. The form-wound coils 10 each have a first connection 18 and a second connection 20. The first connections 18 of the form-wound coils 10 are each connected to first connections 18 of other form-wound coils 10. The same applies to the second connections 20 of the form-wound coils 10.

The connections are established by connecting elements 30. The connecting elements 30 each comprise a flat bar 32, which in each case has an aperture at its end 34a, 34b. These apertures are not visible in the illustration because screws 22 have been screwed through the apertures into the connections 18, 20. The flat bars 32 have a U shape, such that every sixth first connection 18 and every sixth second connection 20 is connected by a connecting element 30 of this kind, without the connecting element 30 being in contact with other connections 18, 20 which are not intended to be connected to one another. Therefore, the connecting elements 30 are not insulated.

It can also be seen that the connecting elements 30 are arranged in different planes. This is possible because the connections 18, 20 of adjacent form-wound coils 10 project to different extents.

The connecting elements 30 which are connected to the second connections 20 have apertures which are at a greater distance from one another than the apertures of the connecting elements 30 which are connected to the first connection 18. This is because—proceeding from a center of the stator 132—the second connections 20 lie on a greater radius than the first connections 18.

Furthermore, the flat bars 32 of the connecting elements 30 are bent or slightly angled, in order that the screws 22 can engage cleanly into the thread of the second connections 20.

FIG. 6 shows an exemplary structure of a stator 132, into the slots 38 of which six form-wound coils 10 are inserted. The form-wound coils 10 are connected to one another by means of connecting elements 30. Here, it is pointed out that the electrical connection is established merely for test purposes in respect of establishing the screw connection. The interconnection of the coils during later use differs from the connection configuration illustrated, and is accordingly merely exemplary. Specifically, the interconnection configuration illustrated in FIG. 6 involves a self-contained strand, that is to say a short circuit. Specifically, all twelve connections of the six coils are connected to one another.

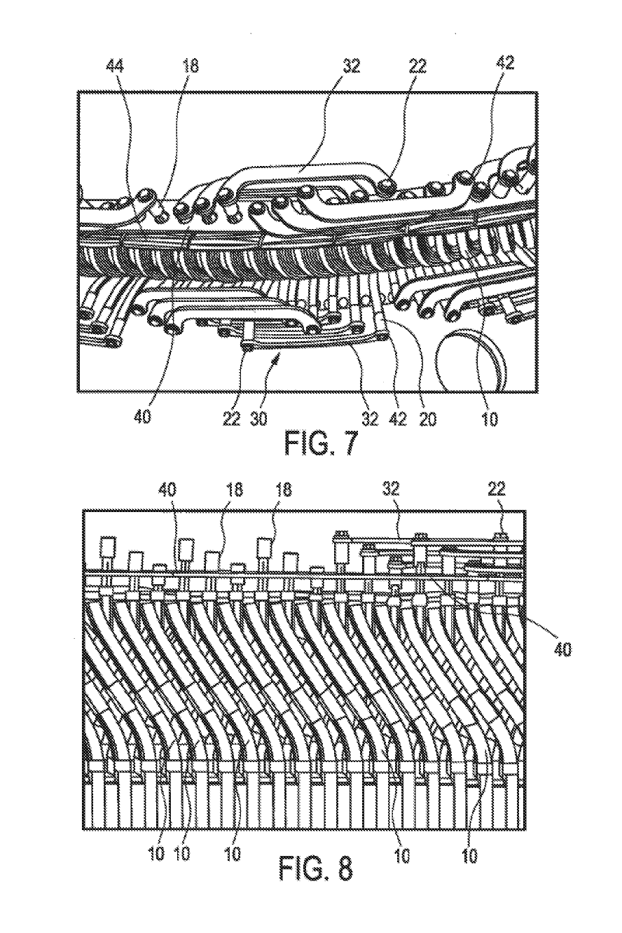

In the left-hand region of the figure, the laminated form of the stator 132 can also be seen in the slots 38 which are not occupied by form-wound coils 10. FIG. 7 is an illustration similar to FIG. 5, with a detail now being shown on an enlarged scale. Once again, the form-wound coils 10 can be seen, which have in each case a first connection 18 and a second connection 20. The first connections 18 have a spacer 40. The spacer 40 to prevent short circuits, specifically in order that adjacent first connections 18 do not come into contact as a result of vibrations.

It can also be seen that adjacent form-wound coils have connections 18, 20 which project to different extents. This yields a sawtooth-like profile of the heights of the connections 18, 20. According to the exemplary embodiment illustrated, the connecting elements 30 have, in addition to the electrical connector 32, which is a flat bar 32 here, and the screws 22, disks 42 which improve the distribution of the force of the screw 22 onto the flat bar 32 when said screw is screwed into the thread of the connections 18, 20. Accordingly, a connecting element 30 has a flat bar 32, two screws 22 and two disks 42 according to a preferred exemplary embodiment.

The spacers 40 correspond to a plastic strip with a plurality of bores through which a plurality of connections 18, 20 are passed in a manner at a distance from one another, before the connecting elements 30 are fitted. Furthermore, a bundle of data lines 44 is illustrated, by way of which temperature sensors, for example, are connected to an evaluation apparatuses.

On account of electrical connectors 32 having a U-shape and the form-wound coils 10 being provided in three different forms with connection regions of three different lengths, the connecting elements 30 are arranged in groups of three. The ends of the same side of U-shaped, electrical connectors 32 of one group are arranged between the ends of the two sides of U-shaped electrical connectors 32 of another group. The ends of the same side of U-shaped conductive connectors 32 of one group are arranged between the ends of the two sides of U-shaped conductive connectors 32 of another group. The stator 132 can therefore be realized with a particularly low space requirement in the axial direction.

FIG. 8 shows a side view, from the center of the stator, of the form-wound coils 10. Here, the abovementioned sawtooth-like profile of the connections 18, 20, in this case of the first connections 18, can be seen particularly clearly. In the left-hand half of the figure, it is possible to see first connections 18 which are not connected to other connections 18 by way of connecting elements 30. The connections 18 accordingly serve as connections for connection to generator terminals, not illustrated.

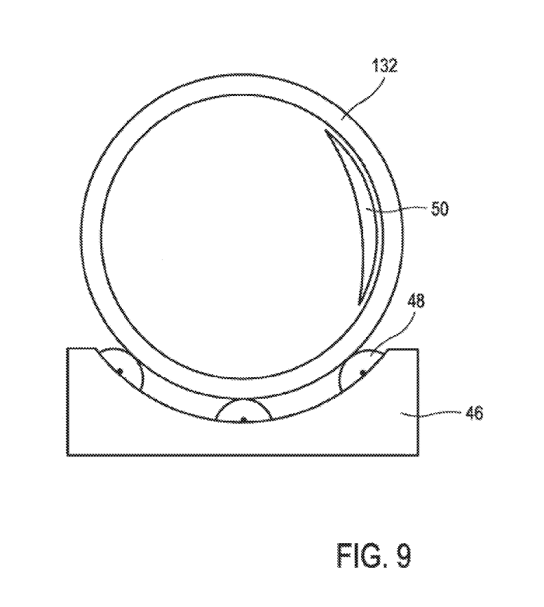

Finally, FIG. 9 shows an auxiliary apparatus 46 for the method. The auxiliary apparatus 46 comprises three rotatable rollers 48 on which the stator 132 is mounted in an upright manner. The stator can be rotated about its axis of rotation or its rotationally symmetrical axis, that is to say an axis through its center, using the auxiliary apparatus 46. A template 50 as an aid for inserting the form-wound coils 10 is also illustrated. The template 50 is arranged in front of a number of slots 38, not illustrated for the purpose of better clarity, and is fixedly held in this position, for example by a releasable connection by way of releasable connecting means, while the stator 132 is rotated on the auxiliary apparatus 46 for the purpose of inserting the form-wound coils.

A worker now inserts the form-wound coils 10 either into the slots 38 in order—depending on the direction of rotation of the stator 132 using the auxiliary apparatus 46—or fastens said form-wound coils to the template 50 in a detachable manner. In this case, the worker can work in the lower region in the center of the stator 132 without a ladder since the auxiliary apparatus 46 makes a ladder or a scaffold unnecessary for the stator 132 which has a diameter of several meters.

Once the stator 132 is fully populated, the stator 132 is turned using the auxiliary apparatus 46 such that the template is arranged in the lower region of the stator 132. The releasable connection of the template 50 to the stator and the form-wound coils are then released and the form-wound coils 10, which had not yet been inserted into the slots 38 owing to the template 50, are inserted into the slots together.

The form-wound coils 10 are not illustrated for the purpose of better clarity.

1. A method for producing a stator of a generator of a gearless wind power installation, comprising:
inserting wherein adjacent form-wound coils into slots of the stator in succession by at least:
only partially inserting a predetermined number of the first form-wound coils into corresponding the slots or positioning the predetermined number of the first form-wound coils in front of the corresponding slots, and
fully inserting the predetermined number of the first form-wound coils into the corresponding slots only together with a predetermined number of the form-wound coils to be inserted last.

2. The method as claimed in claim 1,
at least one of holding the stator upright or rotating the stator to become upright with a substantially horizontal axis of rotation using an auxiliary apparatus when the form-wound coils are inserted into the slots.

3. The method as claimed in claim 1, comprising:
positioning a template, using for the insertion, at least in front of the slots of the form-wound coils to be inserted first and of the form-wound coils to be inserted last,
positioning all of the form-wound coils to be inserted and that are in a region of the template in front of the slots on the template,
inserting the form-wound coils that are in a region without the template into the slots,
removing the template, and
jointly introducing the form-wound coils previously positioned on the template into provided slots.

4. The method as claimed in claim 3, wherein the template has a holding means to hold, in position, a plurality of form-wound coils which are positioned on the template.

5. The method as claimed in claim 1, wherein each of the form-wound coils each have two connections and each of the two connections has one thread, and two connections of different form-wound coils are connected using a conductive connector having two apertures, wherein two screws are respectively screwed through the two apertures into respective threads of the two connections.

6. The method as claimed in claim 5, wherein the two connections and the conductive connector are at least one of: ground or polished in a region of their contact areas before the connection is established.

7. The method as claimed in claim 1, comprising:
fully immersing the stator, after formation, in at least one of: a resin bath or liquid resin, and
removing the stator from the at least one of: the resin bath or liquid resin to allow the resin adhering to the stator to cure.

8-9. (canceled)

10. A form-wound coil of a stator of a generator of a gearless wind power installation, comprising:
an electrical conductor including:
a first connection having a first thread for receiving a first screw and making an electrical connection to a respective further form-wound coil, and
a second connection having a second thread for receiving a second screw and making an electrical connection to a respective further form-wound coil.

11. The form-wound coil as claimed in claim 10, wherein the generator is a ring generator.

12. The form-wound coil as claimed in claim 10, wherein the first and second threads are internal threads.

13. The form-wound coil as claimed in claim 10, wherein:
at least one of the first or second connections of the form-wound coil is angled in relation to a coil longitudinal axis or in relation to a line which is parallel to the coil longitudinal axis, and
at least one other of the first or second connections is not angled in relation to the coil longitudinal axis or in relation to the line which is parallel to the coil longitudinal axis.

14. The form-wound coil as claimed in claim 10, wherein the conductor has a plurality of layers and the plurality of layers are connected to each connection, and the conductor is at least one of a flat copper bar, a copper strip or a flat copper wire.

15. The form-wound coil as claimed in claim 10, wherein the form wound coil has at least four turns in the conductor.

16. The form-wound coil as claimed in claim 10, wherein the form wound coil has one of at least three different forms, wherein the first and second connections of the at least three different forms are at different distances from a geometric center point of the form-wound coil.

17. The form-wound coil as claimed in claim 14, wherein the conductor or each layer of the plurality of layers of the conductor of the form-wound coil is insulated using lacquer or powder coating.

18. The form-wound coil as claimed in claim 10, wherein the first and second connections are each soldered or induction-welded to the conductor.

19. The form-wound coil as claimed in claim 10, wherein the conductor, in a region of connection to at least one of the first and second connections includes an insulation composed of glass-fiber-reinforced plastic for insulating at least one of: at least a part of the conductor, a part of the connection, and wherein at least one of the first and second connections has spacers.

20. The form-wound coil as claimed in claim 10, wherein the conductor and the first and second connections are at least one of copper or copper alloy.

21. A winding structure of a stator of a generator of a wind power installation, comprising:
a plurality of form-wound coils, wherein each form wound coil of the plurality of form-wound coils includes an electrical conductor including:
a first connection having a first thread for receiving a first screw and making an electrical connection to a respective further form-wound coil, and
a second connection having a second thread for receiving a second screw and making an electrical connection to a respective further form-wound coil, and
a plurality of connecting elements, each connecting element being operative to electrically connect two connections of two form-wound coils using screw connections.

22. The winding structure as claimed in claim 21, wherein the plurality of form-wound coils are connected to one another such that the winding structure has six phases, wherein a first and a second strand are associated with a first phase, a third and a fourth strand are associated with a second phase, and a fifth and a sixth strand are associated with a third phase.

23. The winding structure as claimed in claim 21, wherein the winding structure is subdivided into four segments, wherein the segments are connected in parallel.

24. The winding structure as claimed in claim 21, wherein the connections of two form-wound coils are connected by connecting elements, and the connecting elements each comprise a conductive connector that is at least one of: a flat copper bar or a copper strip, and the connecting elements each include two apertures and two screws.

25. The winding structure as claimed in claim 21, wherein the connecting elements and the form-wound coils have a substantially identical coefficients of thermal expansion.

26. The stator of the generator of the wind power installation comprising:
a plurality of circumferential slots, respectively adjacent slots of the plurality of slots are at substantially the same distance from one another,
the plurality of form-wound coils as claimed in claim 20 that are inserted into the plurality of slots.

27. The stator as claimed in claim 26, wherein the form-wound coils are designed in accordance with the winding structure.
